(19) United States
(12) Patent Application Publication
(10) Pub. No.: US 2020/0156337 A1
(43) Pub. Date: May 21, 2020

(54) TEMPERATURE SENSOR, AND METHOD FOR PRODUCING PNEUMATIC TIRE

(71) Applicant: Toyo Tire Corporation, Itami-shi (JP)

(72) Inventor: Rinichi Nakayama, Itami-shi (JP)

(73) Assignee: Toyo Tire Corporation, Itami-shi (JP)

(21) Appl. No.: 16/682,038

(22) Filed: Nov. 13, 2019

(30) Foreign Application Priority Data
Nov. 19, 2018 (JP) 2018-216388

(51) Int. Cl. B29D 30/06

(52) U.S. Cl. CPC B29D 30/0662; B29D 2030/0677

(57) ABSTRACT

The present invention relates to a temperature sensor for measuring a temperature of a rubber, comprising: a protecting pipe; an element pipe extending coaxially with the protecting pipe, other than a tip portion of the element pipe being covered with the protecting pipe and the tip portion being exposed; and a temperature-measuring resistor element held in the element pipe to measure the rubber temperature. It is preferred that a ratio of a diameter (D2) of the protecting pipe to a diameter (D1) of the element pipe (D2/D1 ratio) is from 1.5 to 3.0. It is preferred that the protecting pipe and the element pipe comprise an air layer therebetween.

### BACKGROUND OF THE INVENTION

### Field of the Invention

The present invention relates to a temperature sensor for measuring a temperature of a rubber, and a method for producing a pneumatic tire using this temperature sensor.

### Description of the Related Art

When a pneumatic tire, which is a rubber product, is produced, a vulcanizing step therefor is a step for which a longest period is required. Thus, efforts for shortening the period for the vulcanizing step have been made also at present. However, when the vulcanization of the rubber is insufficient in the vulcanizing step, air generated by vulcanization reaction of the rubber remains in the vulcanized rubber, so that the remaining air may result in a trouble of the tire in the product stage thereof. Accordingly, in an ordinary site where tires are produced, considering, for example, a point that the temperature of unvulcanized green tires which are raw material for the tires, the inside temperature of the molds, and the atmosphere temperature are varied by season factors and others, a margin period about which all of the variations in the vulcanizing step are additionally considered is added to the base period concerned, so as to set the period required for the vulcanizing step.

However, the setting of the margin period is unfavorable for an improvement of tires in productivity. Thus, for every tire, the time of the end of the vulcanization thereof should be determined, and the vulcanizing step should be effectively carried out. For this purpose, it is desired to measure the temperature of the unvulcanized green tire precisely at the time of the vulcanization.

Apart from the above, in general, as temperature sensors, not only thermocouples but also temperature-measuring resistors are used. For example, Patent Document 1 listed below discloses a temperature sensor including a protecting pipe arranged in a fluid path through which a fluid flows, an element pipe arranged inside the protecting pipe, a measuring unit that is arranged inside the element pipe and is for measuring the temperature of the fluid, and a protecting resin-member arranged between the protecting pipe and the element pipe, this protecting member being formed to be capable of inserting the element pipe into the protecting pipe and pulling out the element pipe from the protecting pipe, and being further formed to prevent contact between the protecting pipe and the element pipe by the vibration of the sensor.

### PRIOR ART DOCUMENT

### Patent Document

Patent Document 1: JP-A-2011-7588

### SUMMARY OF THE INVENTION

The temperature sensor described in Patent Document 1 listed above is arranged orthogonally to the flow direction of the fluid, and is designed to resist low-frequency vibrations caused by Karman vortexes following the flow of the fluid. However, this sensor cannot be used to measure the rubber temperature. As described herein, there exist temperature sensors usable in various fields. In the actual situation, however, reports have not been made about temperature sensors suitable for measuring the rubber temperature.

In light of the above-mentioned situation, the present invention has been made. An object thereof is to provide a temperature sensor which can measure a temperature of a rubber precisely, and which is inserted into a rubber portion of an unvulcanized green tire, in particular, in a vulcanizing step of heating and vulcanizing the green tire to make it possible to measure the rubber temperature precisely; and a method for producing a pneumatic tire using this temperature sensor.

The object can be attained by the present invention, which is described as follows: The present invention relates to a temperature sensor, for measuring a temperature of a rubber, including a protecting pipe; an element pipe extending coaxially with the protecting pipe, other than a tip portion of the element pipe being covered with the protecting pipe and the tip portion being exposed; and a temperature-measuring resistor element that is held inside the element pipe and is for measuring the rubber temperature.

The temperature sensor according to the present invention is designed to cover, with the protecting pipe, other than the tip portion of the element pipe in which the temperature measuring resistor element for measuring the rubber temperature is held. For this reason, even when the temperature sensor is inserted into the rubber in the axial direction thereof, the protecting pipe reinforces the element pipe so that the element pipe can be prevented from being damaged.

In the temperature sensor, it is preferable that a ratio of a diameter (D2) of the protecting pipe to a diameter (D1) of the element pipe (D2/D1 ratio) be from 1.5 to 3.0. For example, in a case where at least the tip portion of the element pipe which the temperature sensor has is inserted into a rubber portion of the green tire to measure the temperature of the rubber portion, and further in a case where there is a mold for heating and vulcanizing the rubber portion around the protecting pipe, it is important, for measuring the temperature of the rubber portion precisely, that heat transmitted to the protecting pipe is not transmitted to the element pipe. When, in the present invention, the ratio of the diameter (D2) of the protecting pipe to a diameter (D1) of the element pipe (D2/D1 ratio) is from 1.5 to 3.0, an effect of the heat transmitted to the protecting pipe is restrained so that the temperature of the rubber portion is favorably measurable with a higher precision in the tip portion of the element pipe. A gap created by setting the D2/D1 ratio into this range may be an air layer or a vacuum layer, or may be a heat insulation member layer.

In the temperature sensor, it is preferable that a ratio of the length L1 of the exposed tip portion in the axial direction thereof to the diameter D1 of the element pipe (L1/D1 ratio) be in a range from 2.0 to 3.0. The tip portion of the element pipe is not covered with the protecting pipe to be exposed; thus, when the sensor is inserted into the rubber portion, it is feared that the tip portion is short in strength. However, by setting the L1/D1 ratio in this range, this tip portion can sufficiently ensure strength.

In the temperature sensor, it is preferable that the diameter D1 of the element pipe be 5 mm or less. As the diameter of the element pipe is narrower, the sensor less easily receives the effect of the temperature environment of the surroundings, so that the tip portion is improved in temperature measuring sensitivity. However, when the diameter of the element pipe is made narrower, the strength of the element pipe is simultaneously lowered. Consequently, a fear is heightened that the element pipe may be damaged when the temperature of the rubber portion is measured. In the present invention, however, even when the diameter of the element pipe is narrowed to improve the sensor in sensitivity, portions other than the tip portion are covered with the protecting pipe. This makes it possible to compensate sufficiently for an element-pipe-strength lowering caused by making the element pipe diameter narrower, so that the element pipe can be prevented from being damaged.

A method for producing a pneumatic tire, including a vulcanizing step of heating and vulcanizing an unvulcanized green tire; the vulcanizing step including a temperature-measuring step of measuring a temperature of the unvulcanized green tire through a temperature sensor, the temperature sensor including a protecting pipe, an element pipe extending coaxially with the protecting pipe, other than a tip portion of the element pipe being covered with the protecting pipe and the tip portion being exposed, and a temperature-measuring resistor element held in the element pipe to measure the rubber temperature, the temperature-measuring step being a step of inserting at least the tip portion of the temperature sensor into a rubber portion of the green tire to measure a temperature of the rubber portion.

When the unvulcanized green tire is heated and vulcanized, the temperature sensor according to the present invention is favorably usable for measuring the temperature of the rubber of the tire. This sensor is favorably usable to measure the temperature of a rubber portion of the green tire rubber, in particular, by inserting at least a tip portion of the temperature sensor into the rubber portion of the green tire. This producing method makes it possible to measure the temperature of the rubber portion precisely and heat and vulcanize the unvulcanized green tire. It is therefore possible to determine surely the end time of the vulcanizing step for every tire without setting an extra safety period. For reference, when the unvulcanized green tire is vulcanized, a slowest vulcanization advance portion is its tread portion. Thus, in order to determine the end time of the vulcanizing step with a higher certainty, it is preferable in the temperature-measuring step to insert the tip portion into the tread portion of the green time.

In the pneumatic tire producing method, it is preferable that a ratio of a diameter (D2) of the protecting pipe to a diameter (D1) of the element pipe (D2/D1 ratio) be from 1.5 to 3.0; that the protecting pipe and the element pipe include therebetween an air layer; that a ratio of the length L1 of the exposed tip portion in the axial direction thereof to the diameter D1 of the element pipe (L1/D1 ratio) be from 2.0 to 3.0; and that the diameter D1 of the element pipe be 5 mm or less.

### BRIEF DESCRIPTION OF THE DRAWINGS

FIG. 1 is a tire meridian sectional view illustrating an example of an unvulcanized green tire to be heated and vulcanized in the present invention;

FIG. 2 is a sectional view that schematically illustrates a mold for tire molding that is used in the present invention; and

FIG. 3 is a sectional view illustrating an example of a temperature sensor of the present invention.

### DETAILED DESCRIPTION OF THE PREFERRED EMBODIMENTS

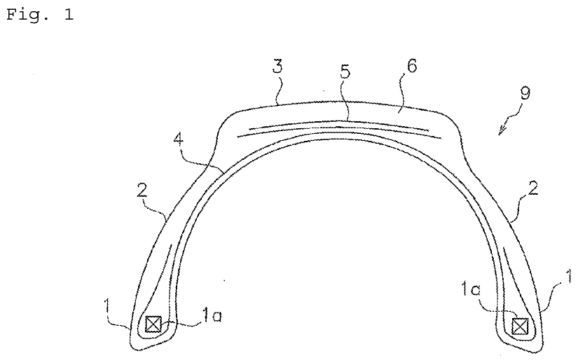

The temperature sensor according to the present invention is inserted into a rubber portion of an unvulcanized green tire, in particular, in a vulcanizing step of heating and vulcanizing the unvulcanized green tire, so that the temperature of the rubber can be precisely measured. Hereinafter, embodiments of the present invention will be described with reference to the drawings. FIG. 1 is a tire meridian sectional view illustrating an example of an unvulcanized green tire to be heated and vulcanized in the present invention. A green tire 9 illustrated therein is a pneumatic tire having a pair of bead portions 1, sidewall portions 2 extending outward from the bead portions, respectively, in the radial direction of the tire, and a tread portion 3 continuous to a tire-radial-direction outside-end of each of the sidewall portions 2 to constitute a tread of the tire. A ring-form bead core 1a is fitted to each of the bead portions 1.

A carcass layer 4 extends from the tread portion 3 through sidewall portions 2 to the bead portion 1. Ends of this layer are each turned back at one of the bead cores 1a. The carcass layer 4 is made of at least one carcass ply. The carcass ply is formed by covering a carcass cord extending at an angle of about 90° to the circumferential direction of the tire with a topping rubber.

A belt layer 5 is bonded to the outside of the carcass layer 4 in the tread portion 3 to be covered with a tread rubber 6 from the outside thereof. The belt layer 5 is made of plural sheets of a belt ply (two sheets of belt plies in the present example). Each of the sheets of belt plies is formed by covering a belt cord extending obliquely to the tire circumferential direction with a topping rubber. Between the sheets of plies, the belt cords are laminated onto each other to cross each other in directions reversed to each other.

The tread rubber 6 may be made of a single layer, and may be formed to have the so-called cap base structure, which has a tire-radial-direction-inside base tread and a cap tread positioned at the circumferential side of the base tread.

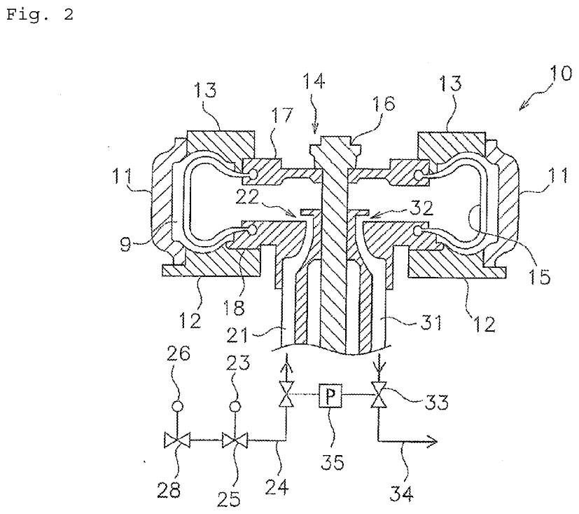

The green tire 9 illustrated in FIG. 1 is a green tire in an unvulcanized state. In a vulcanizing step described below, the green tire is shaped into a shape of a product tire (see FIG. 2), and further a tread pattern that may be in various forms is formed on the surface of the tread.

In the vulcanizing and molding of the green tire 9, a mold for tire-molding (also referred to merely as a “mold” hereinafter) is used. FIG. 2 is a sectional view that schematically illustrates the mold for tire-molding. In this mold 10, the green tire 9 is set in an unvulcanized state, and the green tire 9 in the mold 10 is subjected to heating and pressuring to perform a vulcanizing step.

The mold 10 has at least a tread mold part 11 capable of being caused to contact the tread portion 3 of the green tire 9 to press this portion. In the present example, the mold 10 has the tread mold part 11, which is brought into contact with the tread of the green tire 9, a lower mold part 12 which is downward directed to be brought into contact with the outside surface of the tire, and an upper mold part 13 which is upward directed to be brought into contact with the outside surface of the tire. These portions are displacement-freely configured between a mold-clamped state and a mold-opened state by a switching mechanism (not illustrated) located in the surrounding. This switching mechanism is well known. The tread mold part 11 is further divided into plural segments in the circumferential direction, and can be shifted in the radial direction of the green tire 9 to be located inside the mold 10. Moreover, to the mold 10 is fitted to a platen plate (not illustrated) having a heat source such as an electrical heater or steam jacket. This plate causes each of the mold parts to be heated.

At the center of the mold 10, a central mechanism 14 is located coaxially with the axis of the tire. Around this mechanism, the tread mold part 11, the lower mold part 12 and the upper mold part 13 are set. The central mechanism 14 has a bladder 15 in a rubber bag form, and a center post 16 extending to the tire axial direction. To the center post 16 are fitted an upper clamp 17 and a lower clamp 18 for gripping ends of the bladders 15.

In the central mechanism 14, a medium supply path 21 extends vertically for supplying a heating medium into the bladder 15. A blowout outlet 22 is made at the upper end of the medium supply path 21. To the medium supply path 21 is connected a supply pipe 24 through which the following media flow: the heating medium, which is supplied from a heating medium supply source 23, and a pressuring medium supplied from a pressurizing medium supply source 26. The heating medium is supplied in accordance with a switching operation of a valve 25, and a pressuring medium is supplied in accordance with a switching operation of a valve 28.

Moreover, in the central mechanism 14, a medium discharge path 31 extends vertically for discharging a high-temperature high-pressure fluid produced by mixing the heating medium and the pressurizing medium with each other in the bladder 15. A collecting outlet 32 is made at the upper end of the medium supply path 31. To the medium discharge path 31 is connected a discharge pipe 34 through which the high-temperature high-pressure fluid flows. A blow valve 33 is fitted to the discharge pipe 34 to operate a switching operation of this pipe. A pump 35 may make use of such a manner that the high-temperature high-pressure fluid is forcibly circulated to cause the high-temperature high-pressure fluid that has passed in the medium discharge path 31 to go through the medium supply path 21, so as to resupply this medium into the bladder 15.

In the method for producing a pneumatic tire according to the present invention, a vulcanizing step includes a temperature-measuring step of measuring the temperature of an unvulcanized green tire through the temperature sensor. This temperature-measuring step is a step of inserting at least the tip portion of the temperature sensor into a rubber portion of the green tire to measure the temperature of the rubber portion. In the green tire 9 illustrated in FIG. 1, it is preferable to select, as a rubber portion to which the temperature sensor is to be inserted, the tread portion 3 corresponding to a vulcanization slowest portion of the tire. A method for inserting the temperature sensor into the tread portion 3 may be designed as follows: for example, the temperature sensor is set to make the axial direction of the temperature sensor and the radial direction of the green tire consistent with at least one of the plural segments, which the tread mold part 11 has; and when the tire is vulcanized, the temperature sensor is inserted into the tread portion of the green tire simultaneously with the shift of the segment into the tire radial direction.

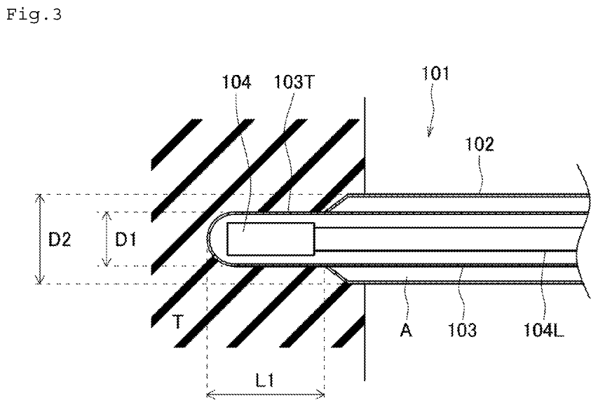

FIG. 3 is a sectional view illustrating an example of a temperature sensor of the present invention. In FIG. 3 illustrates a state that a temperature sensor 101 is inserted into a tread portion T of a green tire in an axial direction thereof. The temperature sensor 101 has a protecting pipe 102; an element pipe 103 extending coaxially with the protecting pipe 102, other than a tip portion 103T of the element pipe being covered with the protecting pipe 102 and the tip portion 103T being exposed; and a temperature-measuring resistor element 104 held in the element pipe 103 to measure the temperature of a rubber. The temperature sensor 101 is fixed by, for example, a fixing means (not illustrated) which the segment of the mold has, and may be set to be directed to the inner circumferential surface side of the tire to be extended into the tire radial direction of the green tire. The wording “inner circumferential surface side” means the central side of the green tire when the green tire is set into the mold. About a fixing means for fixing the temperature sensor, for example, its outer circumferential surface side may be configured of, for example, a double nut, and its inner circumferential surface side may be configured of a screw structure.

The protecting pipe 102 may be made of, for example, a metal member having strength, such as stainless steel. The protecting pipe 102 is designed to cover the element pipe 103 at the outer circumferential surface side of the tire rather than the tip portion 103T, and preferably extends to the fixing means at the inner circumferential surface side end of the mold. An inner circumferential surface side end (tip portion of the element pipe 103) of the protecting pipe 102 is joined with the element pipe 103 without any gap therebetween. As illustrated in FIG. 3, an inner circumferential surface side portion of the protecting pipe 102 is designed in a tapered form to be inserted into the rubber portion without any effort. The element pipe 103 holds therein a temperature-measuring resistor element 104 for measuring the rubber temperature. The temperature-measuring resistor element 104 is preferably made of platinum in order to improve the sensitivity thereof when the rubber temperature is measured. About the position where the temperature-measuring resistor element 104 is held, from the viewpoint of an improvement of the sensor in sensitivity when the rubber temperature is measured, this element is preferably held in the tip portion 103T of the element pipe 103. Lead lines 104L are connected to the temperature-measuring resistor element 104 to transmit voltage information (temperature information) to a recorder not illustrated.

The length of each of the protecting pipe 102 and the element pipe 103 may be appropriately designed in accordance with the sizes of a pneumatic tire to be produced and the mold. The ratio of the diameter D2 of the protecting pipe 102 to the diameter D1 of the element pipe 103 (D2/D1 ratio) is preferably designed into a range from 1.5 to 3.0. According to this structure, a gap A is generated between the protecting pipe 102 and the element pipe 103. However, in the example illustrated in FIG. 3, a gap A between the protecting pipe 102 and the element pipe 103 is an air layer. Thus, by making, for example, a through hole in at least one portion of the outer circumferential surface side end of the protecting pipe, the outer circumferential surface side is an open system. In this case, heat transmitted from the surrounding to the protecting pipe 102 is blocked by the air layer created in the gap A, so that the temperature of the rubber portion is more precisely measured in the tip portion of the element pipe 103. Moreover, also at the outer circumferential surface side of the protecting pipe 102 (rear end side of the element pipe 103), the protecting pipe 102 and the element pipe 103 are joined with each other without any gap. In this way, the gap A between the protecting pipe 102 and the element pipe 103 may be completely in a closed system, or this gap A may be a vacuum layer. Furthermore, the gap A between the protecting pipe 102 and the element pipe 103 may be a layer of a thermal insulation member which is, for example, a resin member, this layer corresponding to the shape of the gap A; or may be a thermal insulation member layer yielded by filling, for example, a fluidal resin member into the gap and then solidifying the member. Examples of the resin member having heat insulation include polytetrafluoroethylene, silicone rubber, and natural rubber.

About the element pipe 103, the ratio of the length L1 of the exposed tip portion 103T in the axial direction thereof to the diameter D1 of the element pipe 103 (L1/D1 ratio) is preferably designed into a range from 2.0 to 3.0 to ensure the strength of the tip portion 103T. As the diameter D1 of the element pipe 103 is narrower, this pipe less likely to receive effects of the temperature environment other than that of the tip portion 103T. Thus, about the temperature measurement of desired one of the rubber portions, the sensitivity of the sensor is favorably improved. Accordingly, the diameter D1 of the element pipe 103 is preferably 5 mm or less, more preferably 3.5 mm or less.

About the temperature sensor according to the present invention, at least a tip portion of its element pipe is inserted into a rubber that is a temperature measuring target, whereby the temperature sensor is useful when the temperature of the rubber is measured. In particular, the temperature sensor according to the present invention is favorably usable for a method for producing a pneumatic tire including a vulcanizing step of heating and vulcanizing an unvulcanized green tire. This producing method makes it possible that the unvulcanized green tire is heated and vulcanized while the temperature of a rubber portion thereof is precisely measured. It is therefore possible to determine surely the end time of the vulcanizing step for every tire without setting an extra safety period.

The structure adopted in each of the above-mentioned embodiments may be applied to any other embodiment of the present invention. A specific structure of each portion or moiety of the temperature sensor of the present invention is not limited only to that in the embodiments. Thus, each of the disclosed embodiments may be variously modified as far as the modified embodiment does not depart from the subject matters of the present disclosure.

### EXPLANATION OF REFERENCES

101 temperature sensor
102 protecting pipe
103 element pipe
104 temperature-measuring resistor element

What is claimed is:

1. A temperature sensor for measuring a temperature of a rubber, comprising:
a protecting pipe; an element pipe extending coaxially with the protecting pipe, other than a tip portion of the element pipe being covered with the protecting pipe and the tip portion being exposed; and a temperature-measuring resistor element held in the element pipe to measure the rubber temperature.

2. The temperature sensor according to claim 1, wherein a ratio of a diameter (D2) of the protecting pipe to a diameter (D1) of the element pipe (D2/D1 ratio) is from 1.5 to 3.0.

3. The temperature according to claim 1, wherein the protecting pipe and the element pipe comprise an air layer therebetween.

4. The temperature according to claim 1, wherein a ratio of a length L1 of the exposed tip portion in an axial direction thereof to the diameter D1 of the element pipe (L1/D1 ratio) is from 2.0 to 3.0.

5. The temperature sensor according to claim 1, wherein the diameter D1 of the element pipe is 5 mm or less.

6. A method for producing a pneumatic tire, comprising a vulcanizing step of heating and vulcanizing an unvulcanized green tire;
the vulcanizing step comprising a temperature-measuring step of measuring a temperature of the unvulcanized green tire through a temperature sensor,
the temperature sensor comprising a protecting pipe; an element pipe extending coaxially with the protecting pipe, other than a tip portion of the element pipe being covered with the protecting pipe and the tip portion being exposed; and a temperature-measuring resistor element held in the element pipe to measure the rubber temperature,
the temperature-measuring step being a step of inserting at least the tip portion of the temperature sensor into a rubber portion of the green tire to measure a temperature of the rubber portion.

7. The pneumatic tire producing method according to claim 6, wherein in the temperature-measuring step, the tip portion is inserted into a tread portion of the green tire.

8. The pneumatic tire producing method according to claim 6, wherein a ratio of a diameter (D2) of the protecting pipe to a diameter (D1) of the element pipe (D2/D1 ratio) is from 1.5 to 3.0.

9. The pneumatic tire producing method according to claim 6, wherein the protecting pipe and the element pipe comprise an air layer therebetween.

10. The pneumatic tire producing method according to claim 6, wherein a ratio of a length L1 of the exposed tip portion in an axial direction thereof to the diameter D1 of the element pipe (L1/D1 ratio) is from 2.0 to 3.0.

11. The pneumatic tire producing method according to claim 6, wherein the diameter D1 of the element pipe is 5 mm or less.
